(19) United States
(12) Patent Application Publication
(10) Pub. No.: US 2015/0099398 A1
(43) Pub. Date: Apr. 9, 2015

(54) CONNECTOR FOR PRINTED CIRCUIT BOARDS

(71) Applicant: Eli BENOLIEL, Or Akiva (IL)

(72) Inventor: Eli BENOLIEL, Or Akiva (IL)

(21) Appl. No.: 14/047,180

(22) Filed: Oct. 7, 2013

(51) Int. Cl. H01R 12/72; H01R 43/20; H01R 13/717; H01R 24/60; H01R 13/66

(52) U.S. Cl. CPC H01R 12/721; H01R 24/60; H01R 13/665; H01R 13/7175; H01R 43/205; H01R 2107/00
USPC 439/630; 29/842

(57) ABSTRACT

A female connector for electrical connection to an edge connector, the edge connector being of predetermined width, the female connector comprising: two parallel outer segments, at least one of the outer segments comprising electrical connections for the edge connector located on an inwardly facing surface thereof; and a spacer spacing the outer segments apart by approximately the edge connector width, the outer segments extending forward of the spacer to fit over corresponding electrical connections on either side of the edge connector to provide electrical connection.

### FIELD AND BACKGROUND OF THE INVENTION

The present invention, in some embodiments thereof, relates to a connector for a printed circuit board and, more particularly, but not exclusively, to a simplification of the manufacturing technique for producing a female connector.

Electrical connectors are extensively used to connect between devices both for power and for communication. In general connectors can be divided into cable connectors and module connectors.

Traditional connectors are based on male and female connector pairs. The male is built of pins and the female is built of tubes. A pin or an array of one or more dimensions of pins are encapsulated together in a certain arrangement to form the male connector, and the female connector is then plugged into the male connector. The female connector has been built of tubes that fit the pins and are arranged in the same pattern as the male connector.

Traditional male connectors are implemented on the ends of a cable, and a female connector may be implemented on the Host. The male connector may be placed directly on the PCB (Printed Circuit Board). The other type of electrical connector is used to interconnect between electronic cards or modules and a host board or backplane.

The most popular interconnect today is called an edge connector which means that the connector is created by creating copper fingers often coated with gold. Such an edge connector is implemented on both sides of the PCB (Printed Circuit Board) and can be implemented at different pitches, pad size and length. To accept an edge connector a female connector is used. The type of female connector suitable for an edge connector, again the most popular edge connector today, is based on flexible pins which may be planar or round and which have been manufactured from an etched metal foil coated with gold which is encapsulated in a plastic case. The case may also include a guide to direct the inserted edge connector. The edge connector dominates the market today. PC cards use edge connectors and USB connectors also use edge connectors.

There are many edge connectors in the market which are different in size, number of pins and speed. With today's high speed interconnects, the connector must introduce minimal losses to the high speed signal passing through. Most of today's connectors are SMT (Surface Mount) which may be assembled automatically on boards using SMT machines.

In general connectors are ubiquitous and the numbers of cables which are used in the world is very large.

### SUMMARY OF THE INVENTION

The present invention relates to a female connector for connecting to an edge connector, in which the female connector is manufactured using PCB technology.

According to an aspect of some embodiments of the present invention there is provided a female connector for electrical connection to an edge connector, the edge connector being of predetermined width, the female connector comprising:

two parallel outer segments, at least one of the outer segments comprising electrical pads for contacting the edge connector, the electrical pads located on an inwardly facing surface thereof; and

a spacer, the spacer spacing the outer segments apart by approximately the predetermined width, the outer segments extending forward of the spacer to fit over corresponding electrical pads on either side of the edge connector to provide the electrical connection.

In an embodiment, the outer segments and the spacers comprise printed circuit boards, and the electrical pads comprise enlargements of metal tracks of the printed circuit boards.

An embodiment may comprise a holder having resilience, the holder holding together the outer segments and the spacer, such that the resilience provides the outer segments with an ability to slide onto the edge connector and maintain a grip on the edge connector.

In an embodiment, both of the parallel outer segments comprise electrical pads on inwardly facing surfaces thereof.

In an embodiment, the outer segments comprise cuts extending between the electrical connectors from an end away from the spacer, the cuts providing the outer segments with a resilience, thereby to slide onto the edge connector and maintain a grip on the edge connector.

In an embodiment, the electrical connectors on the inwardly facing surfaces comprise bumps for enhancing mechanical grip on the edge connector.

An embodiment may include optical fibers inserted between the electrical connectors.

An embodiment may comprise additional electronic circuitry on at least one of the outer segments.

In an embodiment, the additional electronic circuits comprise a laser diode and a photo-detector.

The connector may be fitted over and electrically contacting an edge connector.

According to a second aspect of the present invention there is provided a method of manufacturing a female connector for electrical connections to edge connectors, the edge connectors being of predetermined width, the method comprising:

providing two printed circuit board segments with electrical tracks on one surface respectively;

providing a spacer having a width approximating to a width of the edge connectors;

placing the two printed circuit board segments on either side of the spacer, such that the surfaces having the electrical tracks face inwards towards each other; and

fixing the printed circuit board segments and the spacer together to form a structure slidable onto an edge connector.

The method may comprise cutting intrusions into the two printed circuit board segments in between the tracks, to form resilient finger-like protrusions.

The method may comprise inserting outwardly extending protrusions onto the tracks to grip corresponding tracks of the edge connector.

The method may comprise inserting optical fibers between the tracks.

The method may comprise inserting optical components within the connector.

The method may further comprise inserting electronic components within the connector.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a diagram illustrating a prior edge connector and corresponding female connector;

FIG. 2 is a simplified block diagram illustrating a cross section of a female connector according to the present embodiments and a corresponding edge connector;

FIG. 3 is a simplified block diagram illustrating a fastening for the connector of FIG. 2 and showing how the parts are resilient;

FIG. 4 is a view of an internal face of an outer portion of the female connector of FIG. 2;

FIG. 5 is a view of an internal face of an outer portion of the female connector of an alternative embodiment of the present invention that includes optical fibers;

FIG. 6 is a simplified diagram of an internal face of an outer portion of the female connector of a further alternative embodiment of the present invention in which a laser diode and a photodetector are integrated into the connector;

FIG. 7 is a photograph illustrating the three parts of a female connector according to embodiments of the present invention; and

FIG. 8 is a photograph of an assembled female connector according to an embodiment of the present invention in situ on an edge connector.

### DESCRIPTION OF SPECIFIC EMBODIMENTS OF THE INVENTION

The present invention, in some embodiments thereof, relates to a connector for a printed circuit board and, more particularly, but not exclusively, to a simplification of the manufacturing technique for producing a female connector.

The present invention relates to a female connector for connecting to an edge connector, in which the female connector is manufactured using PCB technology.

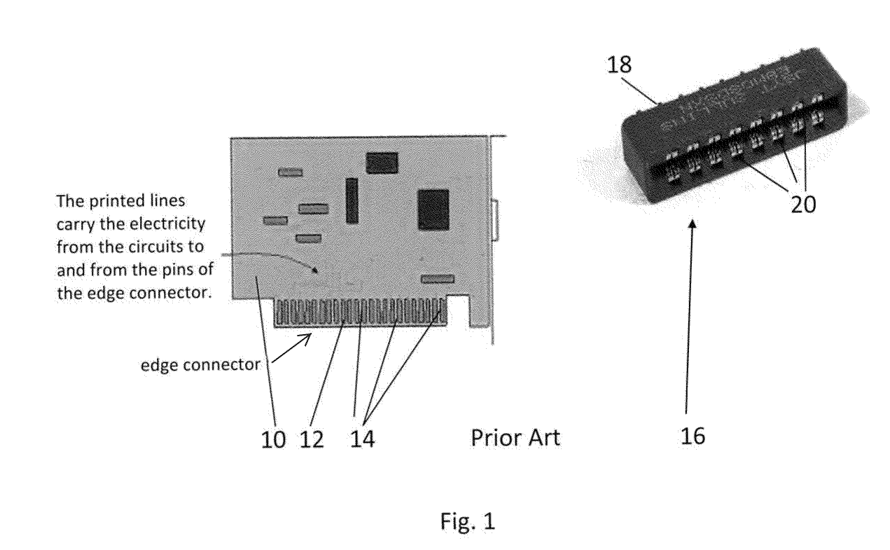

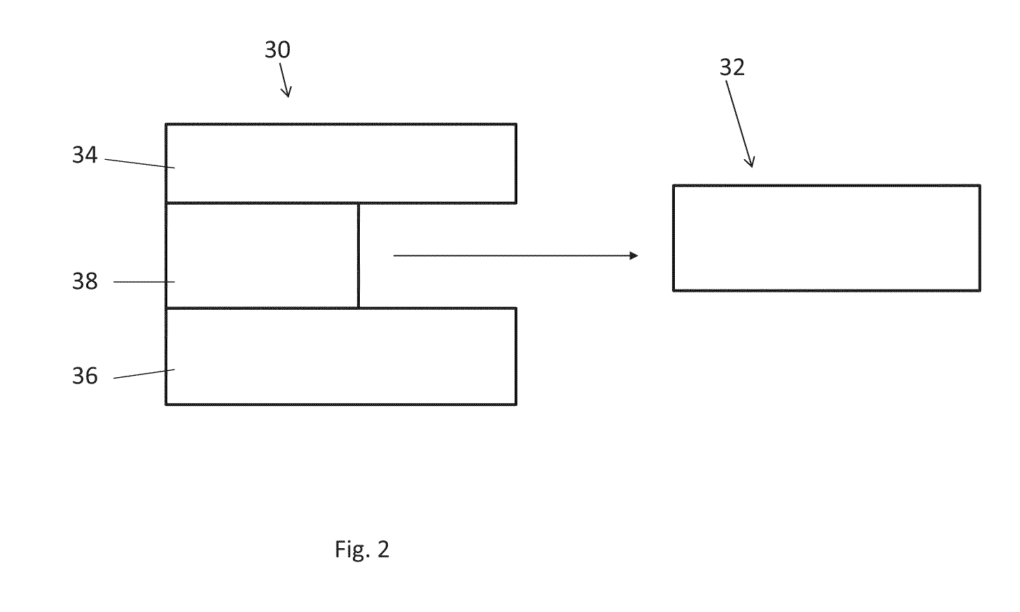

For purposes of better understanding some embodiments of the present invention, as illustrated in FIGS. 2 onwards of the drawings, reference is first made to the construction and operation of an edge connector and a conventional female connector for connecting to the edge connector, as illustrated in FIG. 1.

PCB 10 comprises an edge connector 12. The PCB 10 has circuitry and components and the edge connector has a number of pins 14, each providing outputs from selected locations on the PCB. The edge connector 12 is designed as a protrusion from the PCB so that a female connector can fit securely over it and reliably contact the pins. Female connector 16 comprises a solid outer frame 18 into which flexible metal contacts 20 are built. The flexible metal contacts fit over the pins of the edge connector and the flexibility allows the female connector to grip the PCB and remain in position. The flexible metal contacts need to be individually fitted and have to be massive enough to spring into position around the male contacts, and not break even after numerous insertions and removals.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Referring now to the drawings, FIG. 2 is a simplified cross-sectional schematic diagram which illustrates a female connector 30 for electrical connection to an edge connector 32. Edge connectors are of fixed thicknesses, generally the thickness of a PCB.

The female connector includes two PCB segments 34 and 36. One or both of the segments comprises electrical pads for contacts with corresponding pads on the edge connector and the segments are orientated so that the faces carrying the pads face inwardly. Note the pads are not shown in FIG. 2.

A spacer 38 is placed between the outer segments 34 and 36, and holds them apart by approximately the width of a PCB. The outer segments extend forward of the spacer to fit over the edge connector 32. The electrical pads on the female connector correspond to the electrical pads on either side of the edge connector to provide the electrical connection. Not only the outer segments but also the spacers may conveniently be made from printed circuit boards. The electrical pads being discussed, whether on the male or female connectors, are enlarged metal tracks of the printed circuit boards, typically made of copper or nickel, often coated with gold.

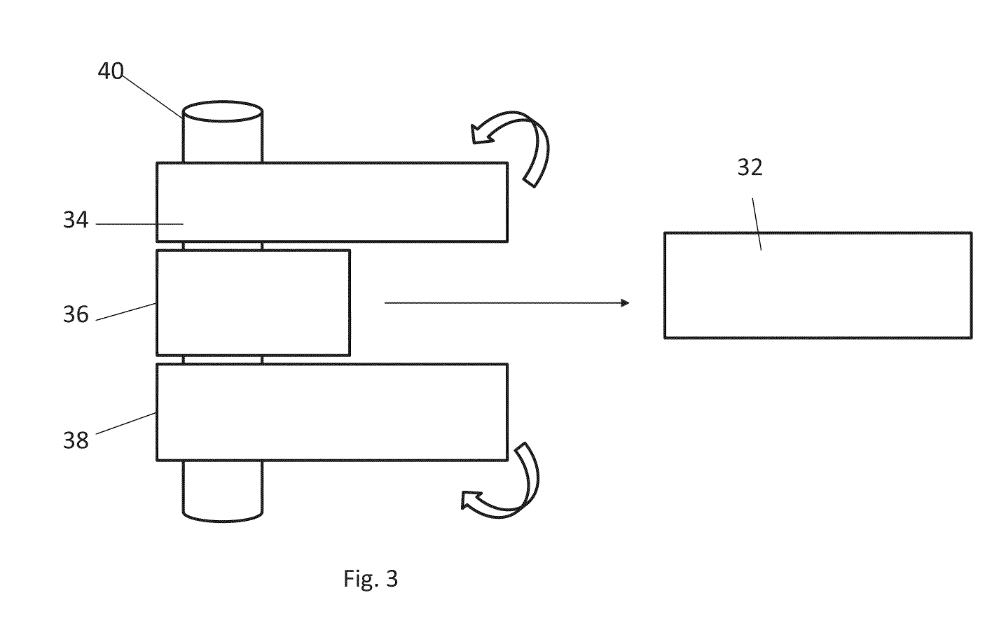

Reference is now made to FIG. 3, which illustrates a fastener 40 for holding the outer segments 34 and 36 to the spacer 38. As shown, the fastener is a screw or peg, but soldering or welding may also be used, as well as any other suitable method. The fastener may have some resilience so that the structure formed is itself resilient, with the outer segments able to be pushed outwards to fit over the edge connector and then press inwardly to grip and form the electrical connection. Thus the outer segments gain an ability to slide onto the edge connector 32 and maintain both a mechanical grip and an electrical connection on the edge connector. In the prior art the resilience is provided by the individual pins, thus requiring each pin to be inserted separately and to have sufficient mass to provide the resilience needed without breaking. In the present invention, the resilience is provided by the surrounding structure, and the electrical pads themselves can be thin, rigid and straightforward to manufacture using standard PCB technology.

Typically, both of the parallel outer segments comprise electrical pads on the inwardly facing surfaces. However in an embodiment, pads are provided on one side only, as necessitated by the circumstances.

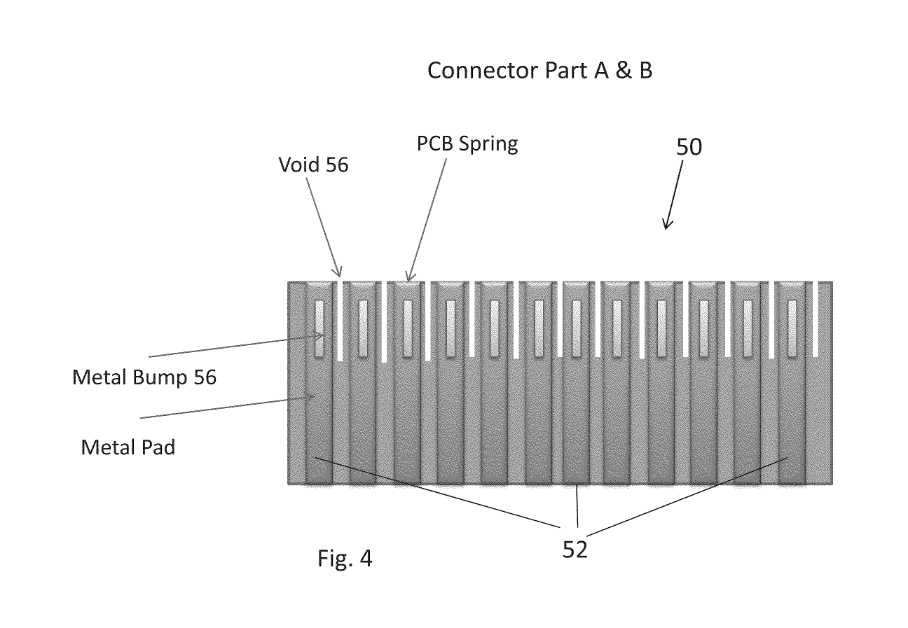

Reference is now made to FIG. 4, which is a simplified diagram showing the inwardly facing side 50 of one of the outer segments. Metal paths 52 are electrical tracks or metal pads on the PCB and may typically be of copper or nickel and may be coated with gold. The pads are arranged in the same way as the corresponding pads on the edge connector that it is designed to connect with, with gaps 54 in between. Slits 56 may be cut into the PCB within the gaps 54 to enhance resilience at the end of the pads. Optionally, metal bumps 58 may be located on the pads to grip the corresponding pads on the edge connector.

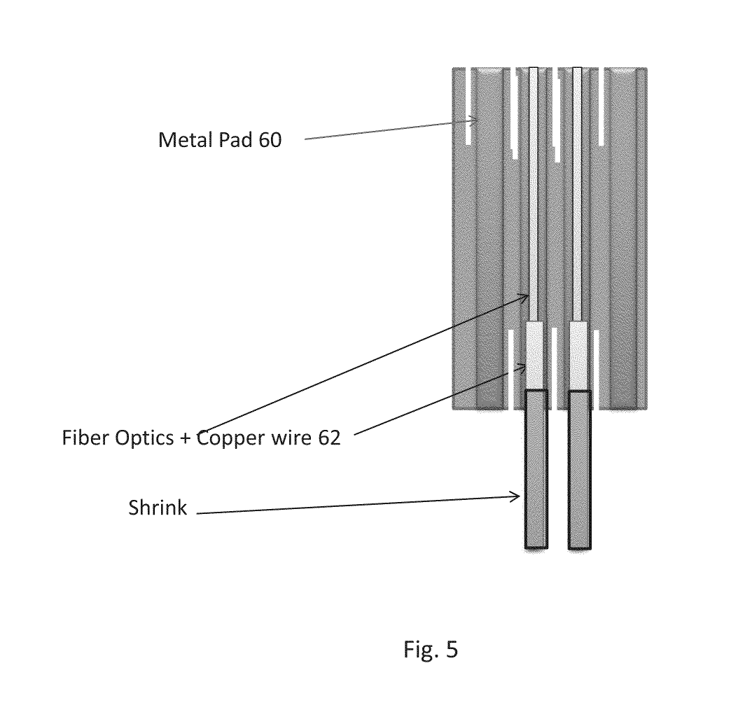

Reference is now made to FIG. 5, which illustrates an embodiment in which the connector provides both optical and electrical connection. The illustration is again of the inwardly facing surface of one of the outer segments. Metal pads 60 are provided as before and optical fibers 62 are inserted between the pads. In order to provide the accuracy of alignment needed for monomode, the optical fibers may be placed in prealigned trenches.

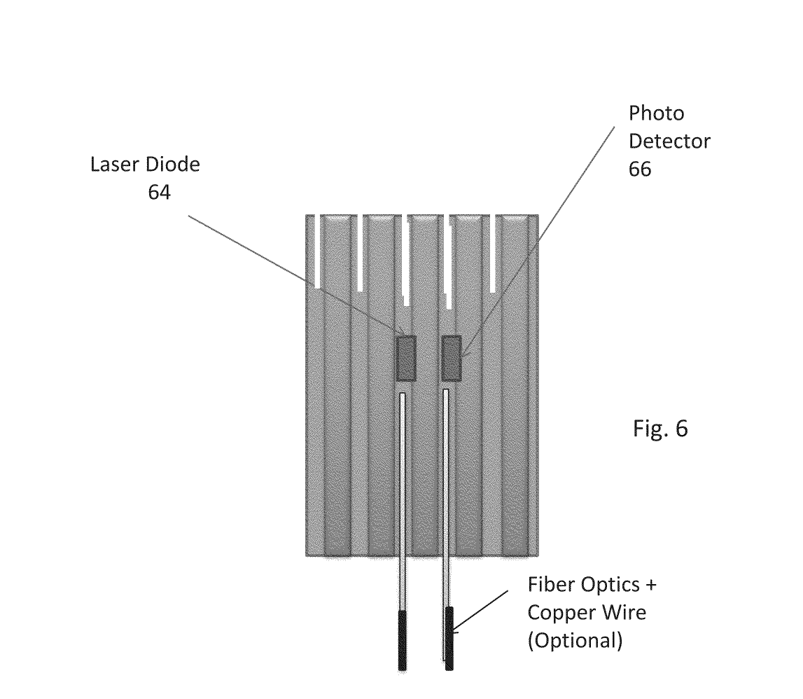

Reference is now made to FIG. 6 which shows a view of the inward facing surface of an outer facing segment according to a further embodiment of the present invention. An advantage of the fact that the connector is a PCB is that additional circuitry and electronic components can easily be included on the connector using standard PCB manufacturing technology. The additional electronic components may for example comprise a laser diode 64 and a photo-detector 66, which can be useful for providing electro-optical functionality. Copper wires carrying electricity may be included with the optical fibers.

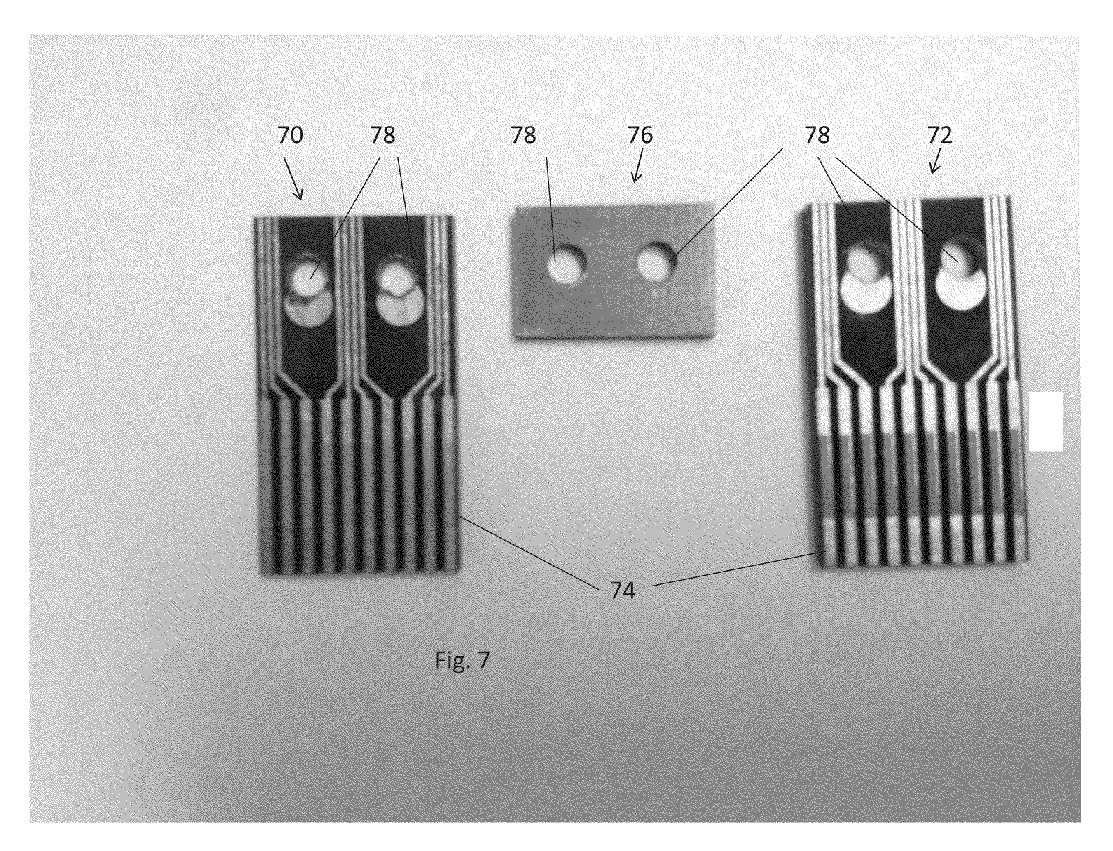

Reference is now made to FIG. 7, which illustrates parts which may be used to assemble a female connector according to the present embodiments.

Two printed circuit board segments 70 and 72 comprise electrical tracks 74 on their surfaces. A spacer 76 has a width approximating to the width of the edge connectors. As shown the segments and the spacer have holes 78 through which a fastener can be connected. It is noted that in the embodiment of FIG. 7 there are no slits between the electrical tracks, so that the resilience is from the PCB itself and from the fastener.

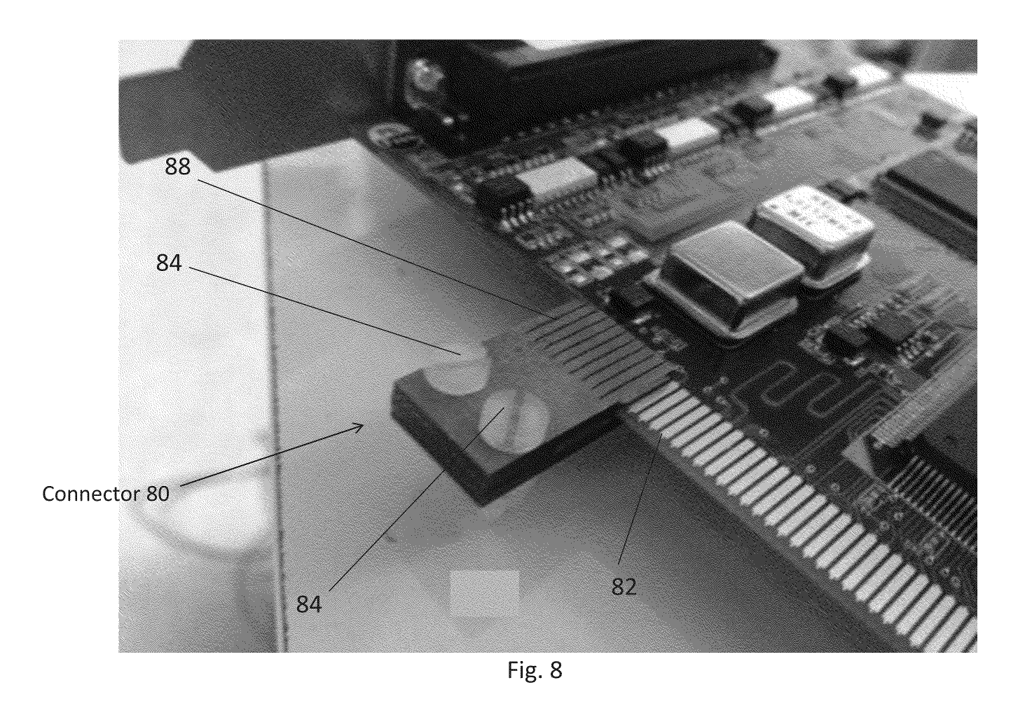

Reference is now made to FIG. 8, which illustrates a female connector 80 constructed from parts similar to those shown in FIG. 7 and fitted over an edge connector 82. Two fasteners 84 hold the connector together through the spacer, and the connector sits over pads of a PCB edge 86. Slits 88 separate the pads of the female connector 80 and contribute springiness to the connector, as discussed.

It is noted that the female connector of FIG. 1 requires the edge connector to jut outwards in order to be able to fit over it. As can clearly be seen from FIG. 8, a connector according to the present embodiments may sit on a part of a much longer edge connector.

The prior art connectors require specific manufacturing technologies both for the female and the male connector. On the cable side the work is even harder, as the pads must be connected to outgoing cables. The present embodiments may provide a simple way for creating female connectors which support standard edge connectors of any size and dimension and provide effective AC/DC performance at low cost using standard PCB manufacturing technologies which are commonly available and are very cheap.

The basic idea of every edge female connector is the fact that the pins are flexible in order to electrically contact and mechanically grip the pad. Since many pins are used together the prior art is unable to have them all implemented on the same solid material such as a PCB. Therefore, in a female connector, each of the pins is an individual construction and has its own freedom to move and touch the pad.

In the present embodiments, as discussed above in respect of FIG. 2, the female connector is assembled from three parts, of which the upper part and lower parts are themselves standard edge connectors. The pads of the female connector however are thicker than the pads of the standard edge connector it is desired to accommodate. For example a standard PCB copper layer is around 1 OZ or 35 micron. Given a pad of 0.8 mm width and 8 mm length, it is possible to add to the edge of such a pad a region having a thickness which is higher by around 10% or a little more or a little less, than the thickness of the male edge connector.

Then the gaps between any two pads may be cut to form slits. The slits mechanically separate the pads into separate fingers of the PCB, each finger being flexible to move freely, the PCB material providing resilience. The spacer may be identical to the outer parts but may have a different pitch.

The spacer preferably has a thickness which is the same as the edge connector that the female connector is being designed for. The three parts are clamped together using a fixing such as a clamp, a peg, a screw, glue or soldering or bonding as convenient. Screwing or soldering is preferred because they may connect the cable, which may comprise wires or flat cables, directly to the PCBs of the female connector. Thus, the manufacturing of the female edge connector can be performed using standard PCB manufacturing technologies as explained above, which means that it is easy to manufacture and the connector becomes a PCB like component. A second advantage is the fact that the female connector can have components built in, as discussed above in respect of FIG. 6, therefore implementing certain functions on the connector itself. For example a wireless high definition multimedia interface (HDMI) adaptor can be implemented directly on the connector PCB, creating a monolithic solution.

When fibers are used to transmit and receive high speed signals, then the fibers may be laid along the cable between the metal pads, as discussed above in respect of FIG. 5. On the connectors, optical chips may be placed directly on the PCB and the fibers aligned. For single mode accuracy the fibers may be aligned in trenches, as discussed in International Patent Application No. WO2012/001693 to OTX Ltd. The disclosed uTOSA/uROSA structures may be used as the spacer for the present embodiments, embedding pre aligned laser and detector chips on a PCB substrate with slots for the fibers, as shown in FIG. 6 herein.

The present embodiments may thus provide a PCB having partially mechanically separated metal pads (PMSMP) in order to create a flexible pad structure on the same hard substrate, which is nevertheless able to interface by sliding over an edge pad or a pressed edge pad.

Sub pads with thicknesses greater than the target pad of the standard edge connector may be made of copper or nickel or any other metal or conductive material suitable to be grown on the PCB metal pad. The connectors may be optionally coated with gold.

The upper and lower PCB parts are clamped together with a middle part, or spacer, having a thickness approximating to the edge connector being designed for. Assembling of the three parts can be done with clamps, glue, soldering material, pegs or screws or any other suitable system.

Optical chips, such as a Laser diode and/or a photodetector can be embedded between the pads allowing connection of fibers which are laid on the cables.

As discussed glass fibers can be laid between the contacts.

An electronic circuit may be implemented on the spacer and/or on the upper and lower parts, say to perform signal/information conversion. The circuits may include power transistors and logic to control and driver a motor or speakers or any other needed interfaces.

It is expected that during the life of a patent maturing from this application improved and relevant PCB manufacturing technologies will be developed and the scope of the terms herein are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the above description is to be construed as if this combination were explicitly written. Conversely, various features of the invention, which are, for brevity, described in the context of a single embodiment, may also be provided separately or in any suitable subcombination or as suitable in any other described embodiment of the invention, and the above description is to be construed as if these separate embodiments were explicitly written. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A female connector for electrical connection to an edge connector, the edge connector being of predetermined width, the female connector comprising:
two parallel outer segments, at least one of said outer segments comprising electrical pads for contacting said edge connector, said electrical pads located on an inwardly facing surface thereof; and
a spacer, the spacer spacing the outer segments apart by approximately said predetermined width, the outer segments extending forward of said spacer to fit over corresponding electrical pads on either side of said edge connector to provide said electrical connection.

2. The female connector of claim 1, wherein said outer segments and said spacers comprise printed circuit boards, and said electrical pads comprise enlargements of metal tracks of said printed circuit boards.

3. The female connector of claim 1, further comprising a holder having resilience, the holder holding together said outer segments and said spacer, such that said resilience provides said outer segments with an ability to slide onto the edge connector and maintain a grip on the edge connector.

4. The female connector of claim 1, wherein both of said parallel outer segments comprise electrical pads on inwardly facing surfaces thereof.

5. The female connector of claim 1, wherein said outer segments comprise cuts extending between said electrical connectors from an end away from said spacer, said cuts providing said outer segments with a resilience, thereby to slide onto the edge connector and maintain a grip on the edge connector.

6. The female connector of claim 4, wherein said electrical connectors on said inwardly facing surfaces comprise bumps for enhancing mechanical grip on the edge connector.

7. The female connector of claim 4, further comprising optical fibers inserted between said electrical connectors.

8. The female connector of claim 1, further comprising additional electronic circuitry on at least one of said outer segments.

9. The female connector of claim 1, wherein said additional electronic circuits comprise a laser diode and a photo-detector.

10. The female connector of claim 1, fitted over and electrically contacting an edge connector.

11. A method of manufacturing a female connector for electrical connections to edge connectors, the edge connectors being of predetermined width, the method comprising:
providing two printed circuit board segments with electrical tracks on one surface respectively;
providing a spacer having a width approximating to a width of the edge connectors;
placing said two printed circuit board segments on either side of said spacer, such that said surfaces having said electrical tracks face inwards towards each other; and
fixing said printed circuit board segments and said spacer together to form a structure slidable onto an edge connector.

12. The method of claim 11, further comprising cutting intrusions into said two printed circuit board segments in between said tracks, to form resilient finger-like protrusions.

13. The method of claim 11, further comprising inserting outwardly extending protrusions onto said tracks to grip corresponding tracks of said edge connector.

14. The method of claim 11, further comprising inserting optical fibers between said tracks.

15. The method of claim 11, further comprising inserting optical components within said connector.

16. The method of claim 11, further comprising inserting electronic components within said connector.
